(19) United States
(12) Patent Application Publication
(10) Pub. No.: US 2010/0124066 A1
(43) Pub. Date: May 20, 2010

(54) COLD CATHODE FLUORESCENT LAMP LIGHTING DEVICE

(76) Inventor: Yu-Chu LIN, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/272,144

(22) Filed: Nov. 17, 2008

(51) Int. Cl. F21V 15/04

(52) U.S. Cl. 362/390

(57) ABSTRACT

A cold cathode fluorescent lamp lighting device includes a light guiding cover having a recess, a cold cathode fluorescent lamp disposed in the recess, and a covering member fitted on the recess of the light guiding cover. The cold cathode fluorescent lamp is provided with at least a cushion. The surface of the covering member is coated with viscose to secure the covering member to the light guiding cover. The cushion and viscose provide dual shock absorption, preventing the cold cathode fluorescent lamp from cracking because of collision.

### BACKGROUND OF THE INVENTION

1. Field of the Invention

The present invention relates to a cold cathode fluorescent lamp lighting device, and more partially to a cold cathode fluorescent lamp having a cushion and a covering member coated with viscose to provide dual shock absorption, preventing the cold cathode fluorescent lamp from cracking because of collision.

2. Description of the Prior Art

An existing vehicle light is provided with a light ring structure to enhance its brightness. A conventional light ring structure comprises a number of light emitting diodes to light and a transparent plastic light guiding cover to form a light ring. The convention light ring structure causes a bright area near the light emitting diodes and a dim area far away from the light emitting diodes. The light from the light ring is not even.

A cold cathode fluorescent lamp lighting device, as disclosed in U.S. Pat. No. 7,287,876 owned by the applicant of the present invention, comprises an annular lens cover, a substantially circular cold cathode fluorescent lamp disposed in the annular lens cover, and a control box. The control box includes wires to control the cold cathode fluorescent lamp to radiate, and is connected with the cold cathode fluorescent lamp to be secured on a vehicle light. The control box is able to control the luminescence of the cold cathode fluorescent lamp. The luminescence from the cold cathode fluorescent lamp is radiated even through the annular lens cover, providing more brightness, evenness and power-saving effects. However, the cold cathode fluorescent lamp is disposed in the annular lens cover. There is a gap between the cold cathode fluorescent lamp and the annular lens cover. When the vehicle light is collided or shocked, the cold cathode fluorescent lamp may be cracked. This is not ideal in use.

### SUMMARY OF THE INVENTION

The primary object of the present invention is to overcome the aforesaid shortcomings.

According to the present invention, there is provided a cold cathode fluorescent lamp lighting device, comprising:
a light guiding cover, having a semicircularly-shaped recess;
a cold cathode fluorescent lamp, disposed in the recess of the light guiding cover;
a covering member, fitted on the recess of the light guiding cover, and
at least a cushion provided on the cold cathode fluorescent lamp.

Preferably, the light guiding cover comprises a post protruding from the recess, the post having a threaded hole for insertion of a bolt.

Preferably, the cold cathode fluorescent lamp is provided with electronic wires.

Preferably, the covering member has a surface coated with viscose for gluing the covering member to the light guiding member.

Preferably, the cushion is in the form of a ring, a circular tube, a C-shaped tube, a pair of semicircular tubes or a semicircular tube with a slab.

The present invention has the following advantages:

1. The cold cathode fluorescent lamp is provided with a cushion to hold against the recess of the light guiding cover, keeping a proper distance to avoid the cold cathode fluorescent lamp from cracking when the vehicle light is collided or shocked.

2. The surface of the covering member is coated with viscose for securing the covering member to the light guiding cover. The viscose has a thickness and elasticity to provide the same cushioning effect. By the dual shock absorption of the cushion and the viscose, the present invention is able to prevent the cold cathode fluorescent lamp from cracking because of collision.

### BRIEF DESCRIPTION OF THE DRAWINGS

FIG. 1 is an exploded view of the present invention;

FIG. 2 is a perspective view of the present invention;

FIG. 3 is a partially sectional view of the present invention;

FIG. 4 is a schematic view showing the present invention coupled to a vehicle light;

FIG. 5 is a schematic view showing a cushion in the form of a circular tube of the present invention;

FIG. 6 is a schematic view showing a cushion in the form of a C-shaped tube of the present invention;

FIG. 7 is a schematic view showing a cushion in the form of a pair of semicircular tubes of the present invention; and

FIG. 8 is a schematic view showing a cushion in the form of a semicircular tube and a slab of the present invention;

### DETAILED DESCRIPTION OF THE PREFERRED EMBODIMENTS

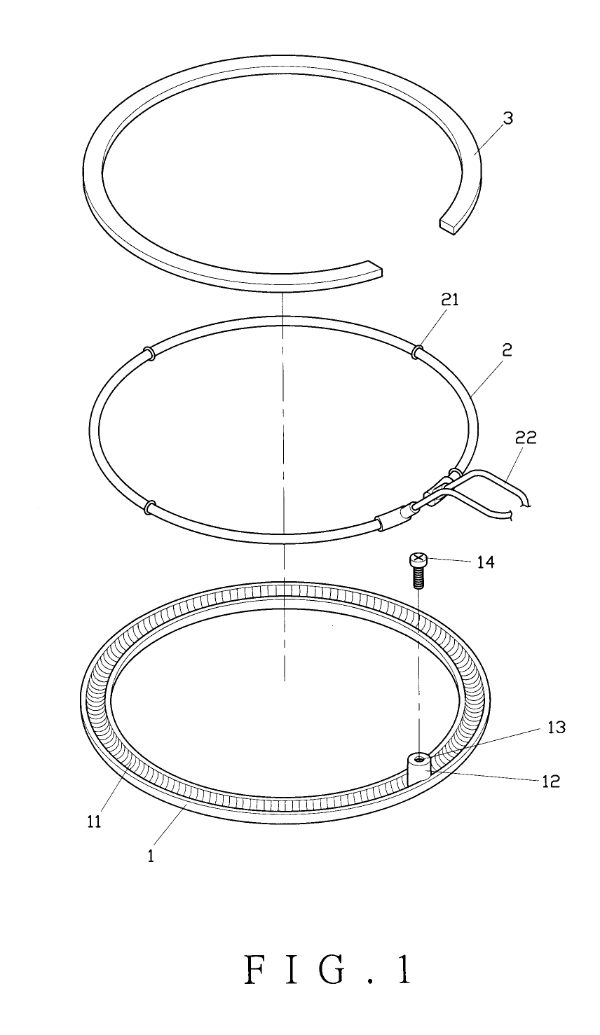

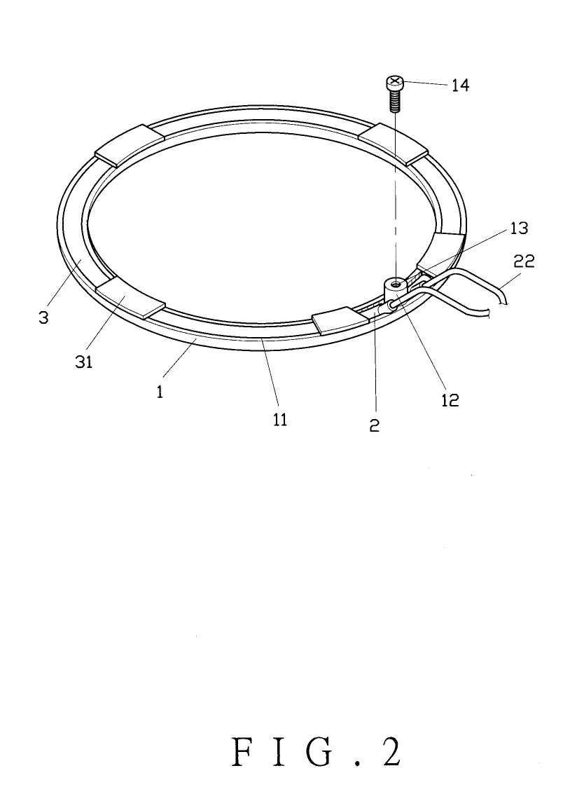

As shown in FIG. 1 and FIG. 2, the present invention comprises a light guiding cover 1, a cold cathode fluorescent lamp 2, and a covering member 3.

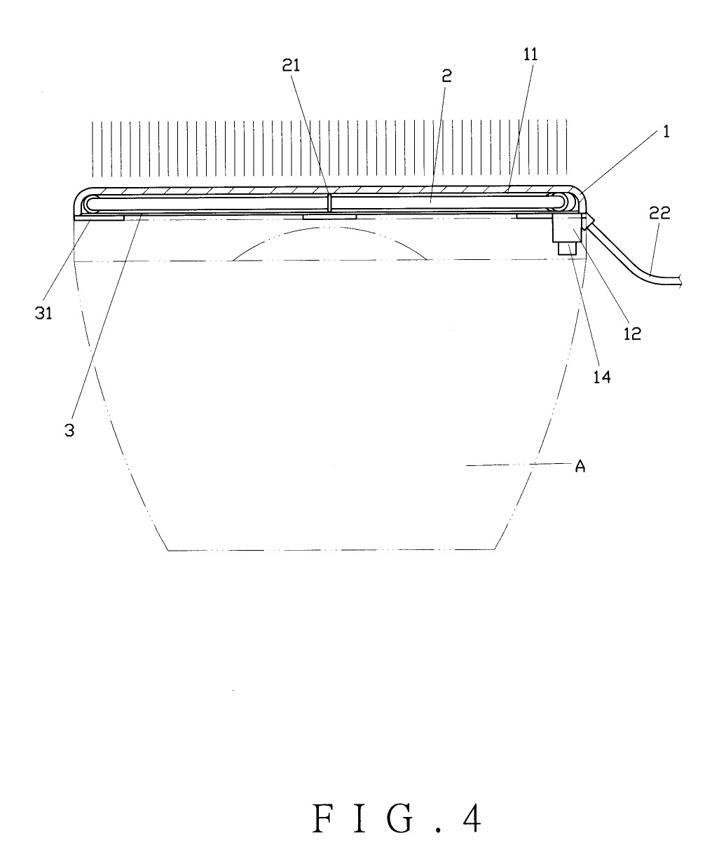

The light guiding cover 1 is an annular shape, and has a semicircularly-shaped recess 11 and a post 12 protruding from the recess 11. The post 12 has a threaded hole 13 for insertion of a bolt 14 to secure the light guiding cover 1 on a vehicle light, as shown in FIG. 4.

The cold cathode fluorescent lamp 2 is disposed in the recess 11, and comprises at least a cushion 21 thereon. The cold cathode fluorescent lamp 2 is provided with electric wires 22 to connect with electric wires from the vehicle light (not shown in the drawings).

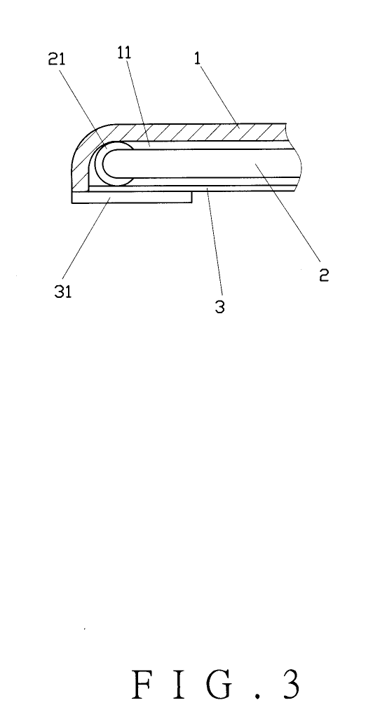

The covering member 3 is secured onto the recess 11 of the light guiding cover 1. The surface of the covering member 3 is coated with viscose 31 for securing the covering member 3 to the light guiding cover 1. The cushion 21 of the cold cathode fluorescent lamp 2 holds against the recess 11 of the light guiding cover 1 and the inner wall of the covering member 3, as shown in FIG. 3, keeping a proper distance between the cold cathode fluorescent lamp 2 and the recess 11 as well as between the cold cathode fluorescent lamp 2 and the inner wall of the covering member 3.

As shown in FIG. 4, the bolt 4 is screwed to the threaded hole 13 of the post 12 of the light guiding cover 1 to secure the present invention on the vehicle light A. This is a conventional technique, not described hereinafter. The covering member 3 with the viscose 31 is attached to the perimeter of the vehicle light A. When the light guiding cover 1 is collided or shocked, the cushion 21 on the cold cathode fluorescent lamp 2 provides a cushioning effect. The viscose 31 of the covering member 3 has a thickness and elasticity to provide a cushioning effect. By the dual shock absorption, the cold cathode fluorescent lamp 2 will not be cracked because of collision.

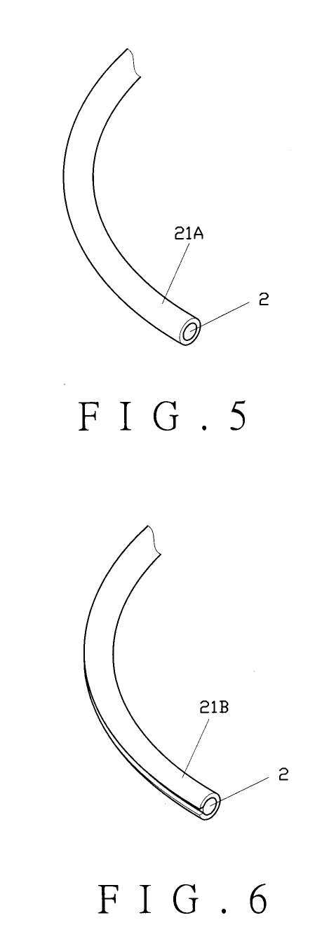

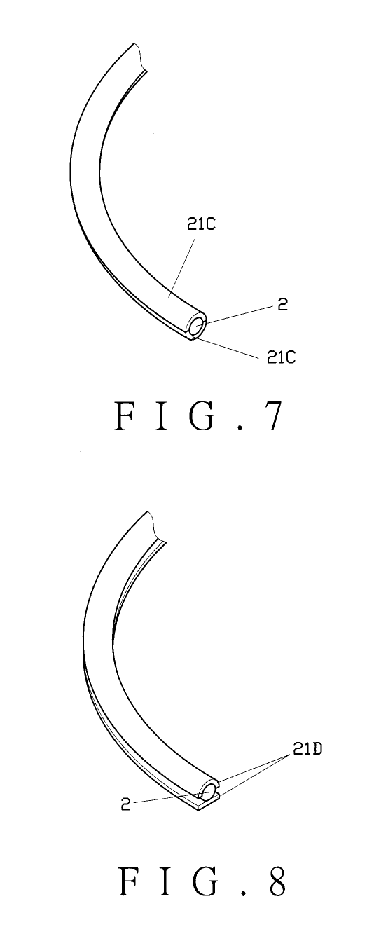

The cushion 21 in the aforesaid embodiment is a ring. As shown in FIG. 5, the cushion 21A may be in the form of a circular tube to wrap and seal the cold cathode fluorescent lamp 2. As shown in FIG. 6, the cushion 21B may be in the form of a C-shaped tube to buckle on the cold cathode fluorescent lamp 2. As shown in FIG. 7, the cushion 21C may be in the form of a pair of semicircular tubes to wrap the cold cathode fluorescent lamp 2. As shown in FIG. 8, the cushion 21D may be in the form of a semicircular tube and a slab to wrap the cold cathode fluorescent lamp 2. To sum up, the different cushions 21, 21A, 21B, 21C and 21D provide the same cushioning effect.

What is claimed is:

1. A cold cathode fluorescent lamp lighting device, comprising:
a light guiding cover, having a semicircularly-shaped recess;
a cold cathode fluorescent lamp, disposed in the recess of the light guiding cover;
a covering member, fitted on the recess of the light guiding cover, and
at least a cushion provided on the cold cathode fluorescent lamp.

2. The cold cathode fluorescent lamp lighting device as claimed in claim 1, wherein the light guiding cover comprises a post protruding from the recess, the post having a threaded hole for insertion of a bolt.

3. The cold cathode fluorescent lamp lighting device as claimed in claim 1, wherein the cold cathode fluorescent lamp is provided with electronic wires.

4. The cold cathode fluorescent lamp lighting device as claimed in claim 1, wherein the covering member has a surface coated with viscose for gluing the covering member to the light guiding member.

5. The cold cathode fluorescent lamp lighting device as claimed in claim 1, wherein the cushion is in the form of a ring.

6. The cold cathode fluorescent lamp lighting device as claimed in claim 1, wherein the cushion is in the form of a circular tube.

7. The cold cathode fluorescent lamp lighting device as claimed in claim 1, wherein the cushion is in the form of a C-shaped tube.

8. The cold cathode fluorescent lamp lighting device as claimed in claim 1, wherein the cushion is in the form of a pair of semicircular tubes.

9. The cold cathode fluorescent lamp lighting device as claimed in claim 1, wherein the cushion is in the form of a semicircular tube and a slab.
